(19) United States
(12) Patent Application Publication
(10) Pub. No.: US 2007/0193424 A1
(43) Pub. Date: Aug. 23, 2007

(54) Potato Ringer

(76) Inventors: Hakim M. Afzalzada, Lancaster, TX (US); Deborah K. Afzalzada, Lancaster, TX (US)

Correspondence Address: ADVANTIA LAW GROUP, 9035 SOUTH 1300 EAST, SUITE 200, SANDY, UT, 84094, US

(21) Appl. No.: 11/307,718

(22) Filed: Feb. 17, 2006

(51) Int. Cl. B26D 7/06; B26D 1/00

(52) U.S. Cl. 83/13; 83/733; 83/932

(57) ABSTRACT

A food ringing apparatus for cutting a food into rings, including a base, a rotating device mounted to the base, and capable of rotating relative to the base, a food holder mounted to the rotating device, and capable of rotating relative to the base, a food mounted on the food holder, a series of vertical blades wherein when the vertical blades are in a disengaged position they do not contact the food, and wherein when the horizontal blades are in an engaged position they are inserted into the food, a series of horizontal blades wherein when the horizontal blades are in a disengaged position they do not contact the food, and wherein when the horizontal blades are in an engaged position they are inserted into the food. The horizontal blades cut the food into stacked slices, and the vertical blades cut the food into vertical concentric tubes. Together, the horizontal and vertical blades cut the food into stacked concentric rings. The food may be a potato.

### BACKGROUND OF THE INVENTION

1. Field of the Invention

The present invention relates generally to a food ringing apparatus and, more particularly, to a device for cutting a food into rings.

2. Description of the Related Art

The art of food processing includes several devices for cutting, dicing, slicing, peeling, and otherwise shaping and preparing food substances before they are consumed. For example, Chinn discloses in U.S. Pat. No. 3,800,649 a hard boiled egg slicing unit having both horizontally and vertically movable slicing portions whereby a hard boiled egg may be selectively sliced along a plurality of parallel and/or transverse planes to provide a wide variation of egg slice shapes. The device, however, is not adaptable for harder food substances such as potatoes, and cannot create rings.

Scallen discloses in U.S. Pat. No. 4,704,959. An apparatus for cutting a potato into a helical shape, the apparatus having a hollow, generally cylindrical body, a cutting plate having a top side and a bottom side located in the body for cutting a potato into a helical shape when a potato is inserted into the body, forced against the cutting plate and rotated around the longitudinal axis of the body, the cutting plate having a plurality of vertical blades for cutting a potato extending perpendicularly upward from the cutting plate and a horizontal blade located above the cutting plate for cutting a potato, and a feeding apparatus for forcing a potato onto the cutting plate and for rotating the potato about the longitudinal axis of the cylindrical body to cut the potato into a helical shape, and an apparatus for cutting an onion into a helical shape, the apparatus having a hollow, generally cylindrical body, a cutting plate having a top side and a bottom side located in the body for cutting an onion into a helical shape when an onion is inserted into the body, forced against the cutting plate and rotated around the longitudinal axis of the body, the cutting plate having a horizontal blade located above the cutting plate for cutting an onion, and a feeding apparatus for forcing an onion onto the cutting plate and for rotating the onion about the longitudinal axis of the cylindrical body to cut the onion into a helical shape.

What is needed is a food ringing device that solves one or more of the problems described herein and/or one or more problems that may come to the attention of one skilled in the art upon becoming familiar with this specification.

### SUMMARY OF THE INVENTION

The present invention has been developed in response to the present state of the art, and in particular, in response to the problems and needs in the art that have not yet been fully solved by currently available food preparation devices. According to one embodiment, the present invention has been developed to provide a food ringing apparatus for cutting a food into rings, including: a base, a rotating device mounted to the base, and capable of rotating relative to the base, a food holder mounted to the rotating device, and capable of rotating relative to the base, a food mounted on the food holder, a series of vertical blades wherein when the vertical blades are in a disengaged position they do not contact the food, and wherein when the horizontal blades are in an engaged position they are inserted into the food, a series of horizontal blades wherein when the horizontal blades are in a disengaged position they do not contact the food, and wherein when the horizontal blades are in an engaged position they are inserted into the food.

The food holder may extend substantially perpendicular to the base. The food holder may include three prongs extending substantially perpendicular to a center line of the food holder. The food may be a potato. The food holder may include a plate mounted to the base substantially parallel to the base. The rotating device may be a motor.

According to one embodiment, the food ringing apparatus may further include controls for controlling the motor. The food ringing device may further include controls for controlling the position of the vertical blades. The food ringing device may further include controls for controlling the position of the horizontal blades.

According to a further embodiment, the present invention includes a method of cutting a food into rings comprising the steps of: inserting a series of vertical blades into the food, inserting a series of horizontal blades into the food, and rotating the food.

In one embodiment, the series of vertical blades and the series of horizontal blades are simultaneously inserted into the food.

In another embodiment, the series of vertical blades do not all extend completely through the food.

In yet another embodiment, the series of horizontal blades do not all extend completely through the food.

According so still a further embodiment, the present invention includes a food ringing apparatus for cutting a food into rings, consisting of: a base, a rotating device mounted to the base, and capable of rotating relative to the base, a food holder mounted to the rotating device, and capable of rotating relative to the base, a food mounted on the food holder, a series of vertical blades wherein when the vertical blades are in a disengaged position they do not contact the food, and wherein when the horizontal blades are in an engaged position they are inserted into the food, a series of horizontal blades wherein when the horizontal blades are in a disengaged position they do not contact the food, and wherein when the horizontal blades are in an engaged position they are inserted into the food.

In another embodiment, the food holder may extend substantially perpendicular to the base. The food holder may include three prongs extending substantially perpendicular to a center line of the food holder. The food may be a potato. The food holder may include a plate mounted to the base substantially parallel to the base. The rotating device may be a motor.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order for the advantages of the invention to be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 illustrates a perspective view of a food ringing device according to one embodiment of the present invention;

FIG. 2 illustrates a cross-sectional view of various components of the food ringing device according to one embodiment of the present invention;

FIG. 3 illustrates a top view of the food holder according to one embodiment of the present invention;

FIG. 4 illustrates a cross-sectional view of various components of the food ringing device in the cutting position according to one embodiment of the present invention; and

FIG. 5 illustrates food rings as prepared by the food ringing device according to one embodiment of the present invention.

### DETAILED DESCRIPTION OF THE INVENTION

For the purposes of promoting an understanding of the principles of the invention, reference will now be made to the exemplary embodiments illustrated in the drawings, and specific language will be used to describe the same. It will nevertheless be understood that no limitation of the scope of the invention is thereby intended. Any alterations and further modifications of the inventive features illustrated herein, and any additional applications of the principles of the invention as illustrated herein, which would occur to one skilled in the relevant art and having possession of this disclosure, are to be considered within the scope of the invention.

Reference throughout this specification to “one embodiment,” “an embodiment,” or similar language means that a particular feature, structure, or characteristic described in connection with the embodiment is included in at least one embodiment of the present invention. Thus, appearances of the phrases “one embodiment,” “an embodiment,” and similar language throughout this specification may, but do not necessarily, all refer to the same embodiment, different embodiments, or component parts of the same or different illustrated invention. Additionally, reference to the wording “an embodiment,” or the like, for two or more features, elements, etc. does not mean that the features are related, dissimilar, the same, etc. The use of the term “an embodiment,” or similar wording, is merely a convenient phrase to indicate optional features, which may or may not be part of the invention as claimed.

Each statement of an embodiment is to be considered independent of any other statement of an embodiment despite any use of similar or identical language characterizing each embodiment. Therefore, where one embodiment is identified as “another embodiment,” the identified embodiment is independent of any other embodiments characterized by the language “another embodiment.” The independent embodiments are considered to be able to be combined in whole or in part one with another as the claims and/or art may direct, either directly or indirectly, implicitly or explicitly.

As used herein, “comprising,” “including,” “containing,” “is,” “are,” “characterized by,” and grammatical equivalents thereof are inclusive or open-ended terms that do not exclude additional, unrecited elements or method steps. “Comprising” is to be interpreted as including the more restrictive terms “consisting of” and “consisting essentially of.”

Finally, the fact that the wording “an embodiment,” or the like, does not appear at the beginning of every sentence in the specification, such as is the practice of some practitioners, is merely a convenience for the reader's clarity. However, it is the intention of this application to incorporate by reference the phrasing “an embodiment,” and the like, at the beginning of every sentence herein where logically possible and appropriate.

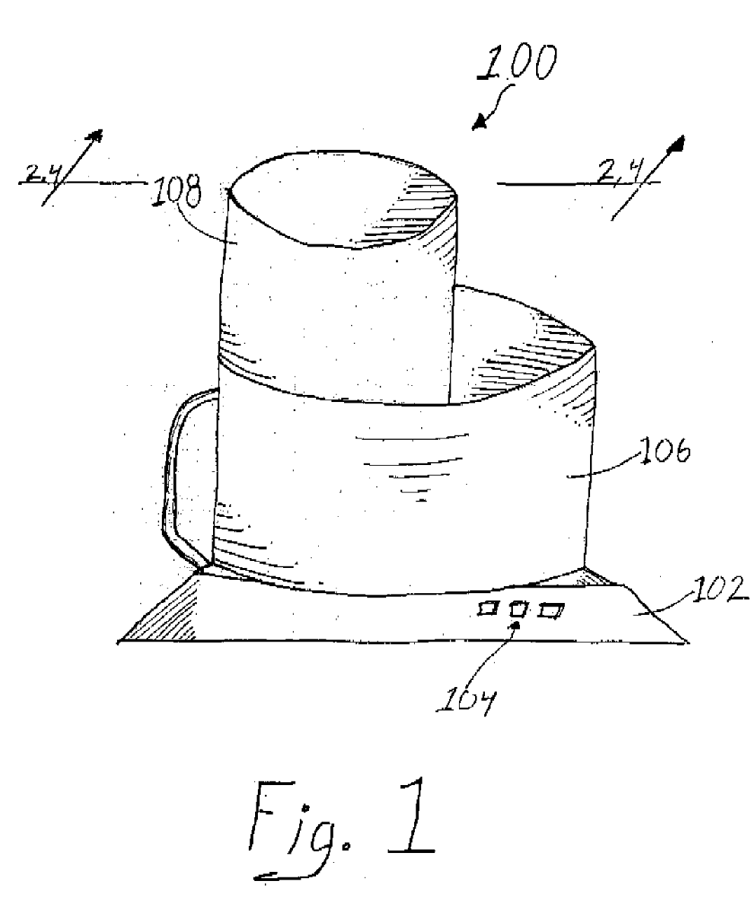

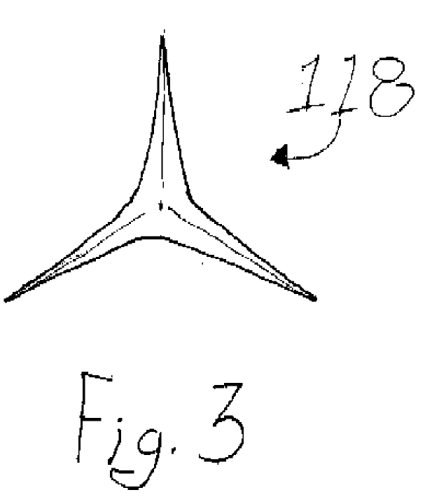

FIGS. 1-4 illustrate a food ringing device 100 according to several embodiments of the present invention. The food ringing device 100 may include a base 102, a food section 106, and a vertical blade section 108. The food ringing device may include control buttons 104 for controlling the operation of the food ringing device 100.

The food ringing device 100 may include vertical blades 124a-c in the vertical blade section 108. When in a retracted position, the vertical blades 124a-c may be in a vertical blade space 112. The vertical blades 124a-c may be attached to a vertical blade housing 128 that is moveable up and down such that the vertical blades may be inserted into the food 116 and/or retracted from the food 116. The food ringing device 100 may also include horizontal blades 126a-h. When in a retracted position, the horizontal blades 126a-h may be in a horizontal blade space 110. The horizontal blades 126a-h may be attached to a horizontal blade housing 130 that is moveable in and out such that the horizontal blades may be inserted into the food 116 and/or retracted from the food 116.

The food ringing device 100 may include a vertical food holder 118 extending from a turning device 120. The food 116 may be placed on the vertical food holder 118. The vertical food holder 118 may be configured to hold the food, and rotate the food. Thus, the vertical food holder 118 may be shaped with sides that assist in rotating the food.

The vertical food holder 118 may be connected to a rotating device 120. The rotating device may be configured to rotate the food while the horizontal and/or vertical blades 126a-h, 124a-c are inserted into the food 116, thus creating slices in the food 116. The rotating device 120 may be an electric motor. The food rotating device 120 may be hand powered.

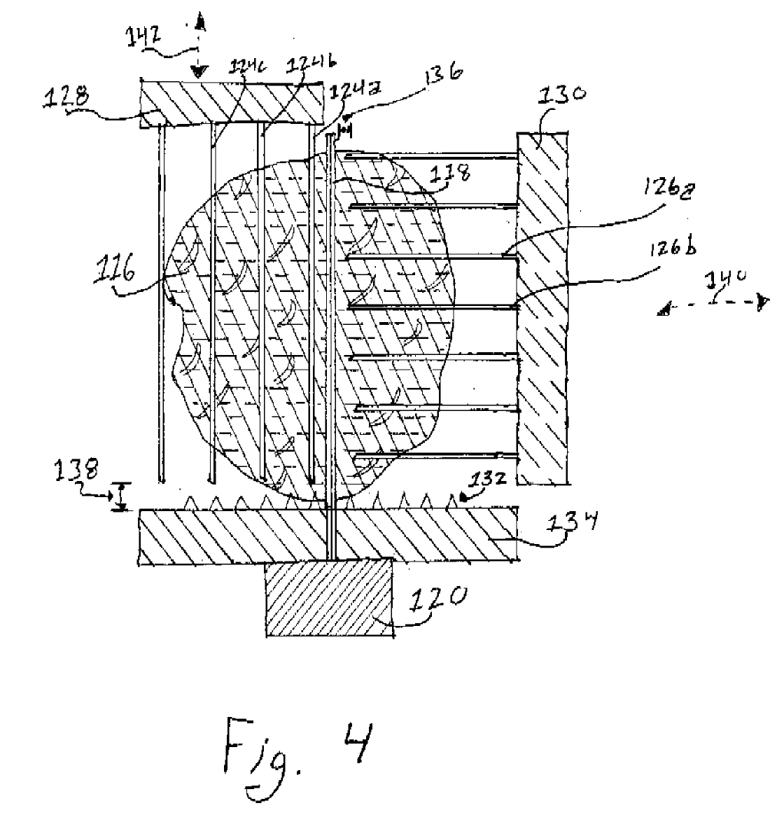

As illustrated in FIG. 4, the food ringing device 100 may include a horizontal food holder 134. The horizontal food holder 134 may be configured to better hold the food 116 and force it to rotate. The horizontal food holder 134 may include spikes 132 configured to hold the food 116. The horizontal food holder 134 may be coupled to the rotating device 120 and/or the vertical food holder 118 such that it rotates the food 116 at the same rate as the vertical food holder 118.

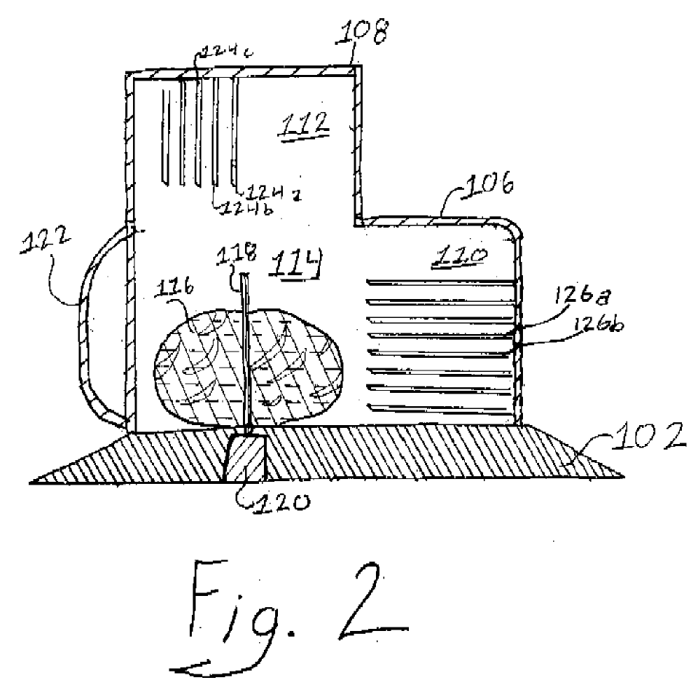

The vertical and horizontal blades 124a-c, 126a-b may be moved from a non-food contacting position (as illustrated in FIG. 2) and a food contacting position (as illustrated in FIG. 4. The vertical blades 124a-c, when in the food contacting position, may leave a gap 138 between the ends of the blades 124a-c and the horizontal food holder 138 and/or an end of the food 116. The horizontal blades 126a-b, when in the food contacting position, may leave a gap 136 between an end of the blades 126a-b, and the vertical food holder 118. The vertical blades 124a-c may be moved between the food-contacting position and the non-food contacting position as indicated by arrows 142. The horizontal blades 126a-b may be moved between the food-contacting position and the non-food contacting position as indicated by arrows 140.

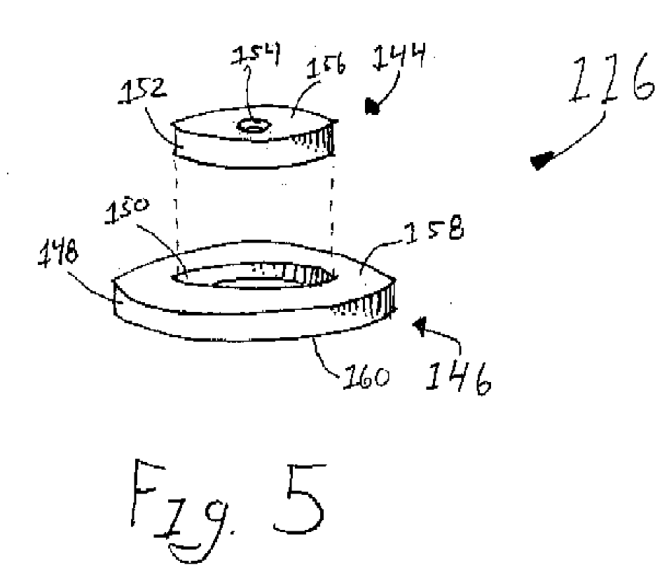

FIG. 5 illustrates food rings 116 as prepared by the food ringing device 100. The horizontal blades 126a-b are inserted into the food 116. As the food 116 is rotated, the blades 126a-b slice the food 116 into discs. The vertical blades 124a-c are inserted into the food 116. As the food 116 is rotated, the blades 124a-c slice the food 116 into concentric tubes. The combination of slicing the food 116 into concentric tubes and slices results in the food 116 being sliced into rings. The horizontal and vertical blades 124a-c, 126a-h may be inserted into the food 116 at the same time, or one set first and the other set second.

The food 116 slices illustrated in FIG. 5 illustrate the surfaces cut by the particular blades of the food ringing device. The center vertical surface 154 of a smaller ring 144 may be cut by vertical blade 124a. The second vertical surface 152 of the smaller ring 144, and the first vertical surface 150 of the larger ring 146 may be cut by vertical blade 124b. The second vertical surface 148 of the larger ring may be cut by vertical blade 124c. The first horizontal surfaces of each piece 156, 158 may be cut by the first horizontal blade 126a. The second horizontal surfaces of each piece 160 may be cut by the second horizontal blade 126b.

Also disclosed herein is a method of cutting a food into rings. The method includes inserting a series of horizontal blades and a series of vertical blades into the food, and rotating the food relative to the blades. The blades may be inserted at the same time, or one series followed by another series. The food may be rotated, or the blades may be rotated, or both.

The food of the present invention may be any capable of being cut into rings. For example, the food may be a fruit such as an apple, a pear, and so forth. The food may be a vegetable such as jicama, turnip, potato, onion, and so forth. The food may be hard-boiled egg, bread, cake, and the like. In one embodiment, the food is potato.

The food may be rotated relative to the blades by any means known. In one example, the food is rotated by hand power. In another embodiment, the food is rotated by a motor. Further, the blades may be inserted by hand power or by a motor. The same motor that rotates the food may be used to insert the blades.

It is understood that the above-described embodiments are only illustrative of the application of the principles of the present invention. The present invention may be embodied in other specific forms without departing from its spirit or essential characteristics. The described embodiment is to be considered in all respects only as illustrative and not restrictive. The scope of the invention is, therefore, indicated by the appended claim rather than by the foregoing description. All changes which come within the meaning and range of equivalency of the claims are to be embraced within their scope.

Finally, it is envisioned that the components of the device may be constructed of a variety of materials.

Thus, while the present invention has been fully described above with particularity and detail in connection with what is presently deemed to be the most practical and preferred embodiment of the invention, it will be apparent to those of ordinary skill in the art that numerous modifications, including, but not limited to, variations in size, materials, shape, form, function and manner of operation, assembly and use may be made, without departing from the principles and concepts of the invention as set forth in the claims.

What is claimed is:

1. A food ringing apparatus for cutting a food into rings, comprising:
a base;
a rotating device mounted to the base, and capable of rotating relative to the base;
a food holder mounted to the rotating device, and capable of rotating relative to the base;
a food mounted on the food holder;
a series of vertical blades wherein when the vertical blades are in a disengaged position they do not contact the food, and wherein when the horizontal blades are in an engaged position they are inserted into the food;
a series of horizontal blades wherein when the horizontal blades are in a disengaged position they do not contact the food, and wherein when the horizontal blades are in an engaged position they are inserted into the food.

2. The food ringing apparatus of claim 1, wherein the food holder extends substantially perpendicular to the base.

3. The food ringing apparatus of claim 2, wherein the food holder includes three prongs extending substantially perpendicular to a center line of the food holder.

4. The food ringing apparatus of claim 1, wherein the food comprises a potato.

5. The food ringing apparatus of claim 1, wherein the food holder includes a plate mounted to the base substantially parallel to the base.

6. The food ringing apparatus of claim 1, wherein the rotating device comprises a motor.

7. The food ringing apparatus of claim 1, further comprising controls for controlling the motor.

8. The food ringing apparatus of claim 1, further comprising controls for controlling the position of the vertical blades.

9. The food ringing apparatus of claim 1, further comprising controls for controlling the position of the horizontal blades.

10. A method of cutting a food into rings comprising the steps of:
inserting a series of vertical blades into the food;
inserting a series of horizontal blades into the food; and
rotating the food.

11. The method of claim 10, wherein the series of vertical blades and the series of horizontal blades are simultaneously inserted into the food.

12. The method of claim 10, wherein the series of vertical blades do not all extend completely through the food.

13. The method of claim 10, wherein the series of horizontal blades do not all extend completely through the food.

14. A food ringing apparatus for cutting a food into rings, consisting of:
a base;
a rotating device mounted to the base, and capable of rotating relative to the base;
a food holder mounted to the rotating device, and capable of rotating relative to the base;
a food mounted on the food holder;
a series of vertical blades wherein when the vertical blades are in a disengaged position they do not contact the food, and wherein when the horizontal blades are in an engaged position they are inserted into the food;
a series of horizontal blades wherein when the horizontal blades are in a disengaged position they do not contact the food, and wherein when the horizontal blades are in an engaged position they are inserted into the food.

15. The food ringing apparatus of claim 14, wherein the food holder extends substantially perpendicular to the base.

16. The food ringing apparatus of claim 15, wherein the food holder includes three prongs extending substantially perpendicular to a center line of the food holder.

17. The food ringing apparatus of claim 14, wherein the food comprises a potato.

18. The food ringing apparatus of claim 14, wherein the food holder includes a plate mounted to the base substantially parallel to the base.

19. The food ringing apparatus of claim 14, wherein the rotating device comprises a motor.
